(19) United States
(12) Patent Application Publication
(10) Pub. No.: US 2025/0029758 A1
(43) Pub. Date: Jan. 23, 2025

(54) Soft Magnetic Powder, Powder Magnetic Core, Magnetic Element, And Electronic Device

(71) Applicant: SEIKO EPSON CORPORATION, Tokyo (JP)

(72) Inventors: Mayu WATANABE, Hachinohe (JP); Mitsutaka INUI, Fujimi (JP)

(21) Appl. No.: 18/776,601

(22) Filed: Jul. 18, 2024

(30) Foreign Application Priority Data
Jul. 19, 2023 (JP) 2023-117441

(51) Int. Cl. H01F 1/153; B22F 1/05; B22F 1/08; B22F 1/142; B22F 3/02; B22F 3/24; B22F 5/10; B22F 9/00; B22F 9/04; B22F 9/08; C22C 38/20; C22C 38/26; C22C 38/32; C22C 38/34; H01F 27/255

(52) U.S. Cl. CPC H01F 1/153; B22F 1/05; B22F 1/08; B22F 1/142; B22F 3/02; B22F 3/24; B22F 5/106; B22F 9/002; B22F 9/04; B22F 9/082; C22C 38/20; C22C 38/26; C22C 38/32; C22C 38/34; B22F 2003/248; B22F 2009/0828; B22F 2201/02; B22F 2301/35; B22F 2304/10; B22F 2998/10; B22F 2999/00; C22C 2202/02; H01F 27/255

(57) ABSTRACT

A soft magnetic powder has a composition represented by FeₓCuₐNb_{b}(Si_{1-y}(B_{1-z}Cr_{z})_{y})_{100-x-a-b} [where a, b, x, y, and z satisfy 0.3≤a≤2.0, 2.0≤b≤4.0, 75.5≤x≤79.5, 0.55≤y≤0.91, and 0.015≤z≤0.185], and includes an amorphous phase and a crystalline phase, wherein defining a content of Cr determined by OES as X(Cr), and a content of Cr and a content of B in the amorphous phase determined by EDX as Y(Cr) and Y(B), the formulas (1) and (2) are satisfied:

$$X ( Cr ) < Y ( Cr ) \leq X ( Cr ) + 1. \qquad ( 1 )$$

$$3. \leq Y ( B ) \leq 15. . \qquad ( 2 )$$

The present application is based on, and claims priority from JP Application Serial Number 2023-117441, filed Jul. 19, 2023, the disclosure of which is hereby incorporated by reference herein in its entirety.

### BACKGROUND

### 1. Technical Field

The present disclosure relates to a soft magnetic powder, a powder magnetic core, a magnetic element, and an electronic device.

### 2. Related Art

In various mobile devices provided with a magnetic element including a powder magnetic core, in order to achieve a reduction in size and an increase in output, it becomes necessary to cope with a high frequency as a conversion frequency of a switching power supply, and a high current thereof. Accordingly, the soft magnetic powder provided in the powder magnetic core is also required to cope with the high frequency and the high current.

In JP-A-2019-189928 discloses a soft magnetic powder having a composition represented by FeₓCuₐNb_{b}(Si_{1-y}B_{y})_{100-x-a-b} [where a, b, and x are each expressed by at %, and are numbers satisfying 0.3≤a≤2.0, 2.0≤b≤4.0, and 73.0≤x≤79.5, and Y is a number satisfying f(x)≤y<0.99, and f(x)=(4×10⁻³⁴)x^{17.56}], and containing 30 volume % or more of crystal structure having a grain size of 1.0 nm or more and 30.0 nm or less. Such a soft magnetic powder is high in magnetic permeability and can realize a downsized magnetic element. In addition, since such a soft magnetic powder contains minute crystals, it is possible to achieve low iron loss in a high-frequency band.

JP-A-2019-189928 is an example of the related art.

However, the soft magnetic powder described in JP-A-2019-189928 has a problem that the soft magnetic powder is easily oxidized depending on the composition, and the density during molding cannot sufficiently be increased. The density of a molded article affects the magnetic permeability of the magnetic element having a powder magnetic core. Accordingly, there is a problem of realizing a soft magnetic powder with which a molded article excellent in oxidation resistance and high in density and magnetic permeability can be manufactured.

In order to achieve a reduction in iron loss in the high frequency band, it is important to reduce coercive force which causes a hysteresis loss. However, the soft magnetic powder described in JP-A-2019-189928 is insufficient in reducing the coercive force.

Further, in the soft magnetic powder described in JP-A-2019-189928, it is also disclosed that an amorphous structure and a minute crystalline structure are mixed with each other. In order to realize such a configuration, it is necessary to perform a heat treatment on the powder to partially crystallize the powder after producing the powder occupied by the amorphous structure. However, in the soft magnetic powder described in JP-A-2019-189928, the coercive force after the heat treatment is apt to vary depending on the conditions of the heat treatment. Therefore, there is also a problem of efficiently manufacturing the soft magnetic powder low in coercive force.

Therefore, there is a problem to realize a soft magnetic powder with which a green compact high in density and magnetic permeability can be manufactured, and which is low in coercive force, and is easily manufactured.

### SUMMARY

A soft magnetic powder according to an application example of the present disclosure has a composition determined by an optical emission spectrometer (OES) represented by a composition formula in an atomic number ratio FeₓCuₐNb_{b} (Si_{1-y}(B_{1-z}Cr_{z})_{y})_{100-x-a-b}, wherein
a, b, x, y, and z satisfy

$$0.3 \leq a \leq 2. ,$$

$$2. \leq b \leq 4. ,$$

$$75.5 \leq x \leq 79.5 ,$$

$$0.55 \leq y \leq 0.91 ,$$

$$and$$

$$0.015 \leq z \leq 0.185 ] ,$$

the soft magnetic powder including:
an amorphous phase which is formed of an amorphous structure in which Fe is an element highest in concentration; and
a crystalline phase which is formed of a crystalline structure in which Fe is an element highest in concentration, wherein
defining a content [at %] of Cr determined by OES as X(Cr), and a content [at %] of Cr and a content [at %] of B in the amorphous phase determined by an energy dispersive X-ray fluorescence spectrometer (EDX) as Y(Cr) and Y(B), the following formulas (1) and (2) are satisfied,

$$\\ \begin{matrix}X ( Cr ) < Y ( Cr ) \leq X ( Cr ) + 1. & ( 1 )\end{matrix}$$

$$\\ \begin{matrix}3. \leq Y ( B ) \leq 15. & ( 2 )\end{matrix}$$

A powder magnetic core according to an application example of the present disclosure includes the soft magnetic powder according to the application example of the present disclosure.

A magnetic element according to an application example of the present disclosure includes a powder magnetic core according to the application example of the present disclosure.

An electronic device according to an application example of the present disclosure includes the magnetic element according to the application example of the present disclosure.

### BRIEF DESCRIPTION OF THE DRAWINGS

FIG. 1 is a view schematically showing an observation image obtained by observing in an enlarged manner a cross section of a particle of a soft magnetic powder according to an embodiment.

FIG. 2 is a plan view schematically showing a toroidal type coil component.

FIG. 3 is a transparent perspective view schematically showing a closed magnetic circuit type coil component.

FIG. 4 is a perspective view showing a configuration of a mobile personal computer which is an electronic device including a magnetic element according to the embodiment.

FIG. 5 is a plan view illustrating a configuration of a smartphone which is an electronic device including the magnetic element according to the embodiment.

FIG. 6 is a perspective view showing a configuration of a digital still camera which is an electronic device including the magnetic element according to the embodiment.

### DESCRIPTION OF EMBODIMENTS

A soft magnetic powder, a powder magnetic core, a magnetic element, and an electronic device of the present disclosure will hereinafter be described in detail based on preferred embodiments illustrated in the accompanying drawings.

### 1. Soft Magnetic Powder

The soft magnetic powder according to the embodiment is a powder exhibiting soft magnetism properties. The soft magnetic powder can be applied to any purposes, and for example, particles of the soft magnetic powder are bound with each other via a binder, and the soft magnetic powder is used for manufacturing various green compacts such as a powder magnetic core or an electromagnetic wave absorber.

### 1.1. Outline of Soft Magnetic Powder

In the soft magnetic powder according to the embodiment, a composition determined by an optical emission spectrometer (OES) satisfies a composition formula in an atomic number ratio FeₓCuₐNb_{b} (Si_{1-y}(B_{1-z}Cr_{z})_{y})_{100-x-a-b} [where a, b, x, y, and z satisfy

$$\\ 0.3 \leq a \leq 2. , 2. \leq b \leq 4. , 75.5 \leq x \leq 79.5 , 0.55 \leq y \leq 0.91 , and$$

$$\\ 0.015 \leq z \leq 0.185 ] .$$

An optical emission spectrometer is an apparatus that performs a pretreatment on the soft magnetic powder, performs chemical analysis on a sample formed as a solution, and quantifies the concentration of each element. Accordingly, the composition obtained by the OES is the composition of the entire soft magnetic powder.

Examples of the pretreatment include pretreatments specified in JIS G 1258-0:2017, JIS G 1258-1:2014, JIS G 1258-2:2014, JIS G 1258-3:2014, JIS G 1258-4:2007, JIS G 1258-5:2007, JIS G 1258-6:2007, JIS G 1258-7:2007, and JIS G 1258-8:2017.

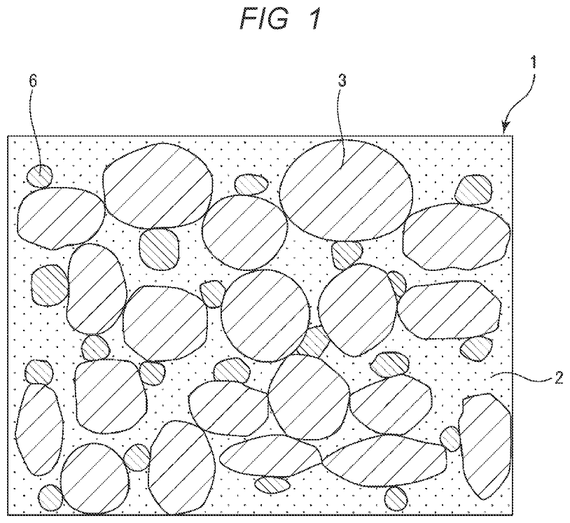

FIG. 1 is a diagram schematically showing an observation image obtained by observing in an enlarged manner a cross section of a particle 1 of the soft magnetic powder according to the embodiment. That is, FIG. 1 is a partial enlarged view of a cross section of one particle 1.

The particle 1 shown in FIG. 1 has an amorphous phase 2 formed of an amorphous structure and a crystalline phase 3 formed of a crystalline structure. In the particle 1 as shown in, for example, FIG. 1, the amorphous phase 2 is in a matrix, and the granular crystalline phases 3 are dispersed in the matrix.

The amorphous phase 2 has an amorphous structure containing Fe as an element having the highest concentration. The crystalline phase 3 is formed of a crystalline structure containing Fe as an element having the highest concentration. The particle 1 may contain a phase other than the amorphous phase 2 and the crystalline phase 3. Examples of the other phase include a Cu segregation phase 6 shown in FIG. 1, which is formed of a crystalline structure containing Cu as an element having the highest concentration.

Here, the Cr content [at %] determined by OES is defined as X (Cr), and the Cr content [at %] and the B content [at %] of the amorphous phase 2 determined by an energy dispersive X-ray fluorescence spectrometer (EDX) are defined as Y (Cr) and Y (b). At this time, the soft magnetic powder according to the embodiment satisfies the following formulas (1) and (2).

$$\\ \begin{matrix}X ( Cr ) < Y ( Cr ) \leq X ( Cr ) + 1. & ( 1 )\end{matrix}$$

$$\\ \begin{matrix}3. \leq Y ( B ) \leq 15. & ( 2 )\end{matrix}$$

In such soft magnetic powder, Cr is added to the known five elements of Fe, Cu, Nb, Si, and B, and the addition amount thereof is optimized. Cr is unevenly distributed in the amorphous phase 2. Specifically, as represented by the above formula (1), the Cr content in the amorphous phase 2 determined by EDX is higher than the Cr content in the entire powder determined by OES. The amorphous phase 2 contains B at a predetermined content. Specifically, as represented by the above formula (2), the B content in the amorphous phase 2 determined by EDX falls within a predetermined range.

According to the above configuration, the oxidation resistance of the soft magnetic powder can be enhanced. As a result, when the soft magnetic powder is compressed, it is possible to suppress a decrease in density of the green compact due to the oxide. As a result, the magnetic permeability of the green compact can be increased.

In the soft magnetic powder according to the embodiment, the amorphous phase 2 in which Cr is unevenly distributed is stabilized, and coarsening of the crystalline phase 3 is suppressed. Therefore, it is possible to reduce the coercive force of the soft magnetic powder according to the embodiment. The stabilization of the amorphous phase 2 means that the amorphous phase 2 easily maintains an amorphous state.

Further, in order to mix the amorphous phase 2 and the crystalline phase 3, it is necessary to manufacture the powder occupied by the amorphous phase 2 and then partially crystallize the powder by performing a heat treatment (crystallization treatment). In this case, the grain size (crystallite diameter) of the crystalline phase 3 is apt to change depending on the conditions of the crystallization treatment, and the coarse crystalline phase 3 may be generated. The coarse crystalline phase 3 causes an increase in coercive force. In contrast, in the soft magnetic powder according to the embodiment, since Cr is added at a predetermined concentration, the amorphous phase 2 can easily be stabilized. As a result, the coarsening of the crystalline phase 3 is easily suppressed regardless of the conditions of the crystallization treatment. That is, according to the above configuration, a low coercive force can easily be realized without performing an operation of, for example, significantly increasing the temperature rising rate for the purpose of preventing excessive crystallization. Accordingly, the soft magnetic powder according to the present embodiment can easily be manufactured.

In the soft magnetic powder according to the embodiment, the crystallite diameter measured by X-ray diffraction is preferably 20.0 nm or less. This makes it possible to sufficiently reduce the coercive force of the soft magnetic powder.

The soft magnetic powder according to the embodiment will be described in detail below.

### 1.2. Composition

As described above, the soft magnetic powder according to the embodiment has a composition determined by OES and represented by the composition formula formed of Fe, Cu, Nb, Si, and B described above.

Fe (iron) greatly affects basic magnetic properties and mechanical properties of the soft magnetic powder according to the embodiment.

The content x of Fe is 75.5 at % or more and 79.5 at % or less, preferably 76.0 at % or more and 78.5 at % or less, and more preferably 76.5 at % or more and 78.0 at % or less. When the content x of Fe is less than the lower limit value, the saturation magnetic flux density of the soft magnetic powder decreases. On the other hand, when the content x of Fe exceeds the upper limit value, the amorphous structure cannot be stably formed when manufacturing the soft magnetic powder, and thus the crystallite diameter becomes excessive and the coercive force increases.

Cu (copper) tends to be separated from Fe when the soft magnetic powder according to the embodiment is manufactured from a raw material. Therefore, when Cu is contained, fluctuation occurs in the composition, and a region where crystallization is apt to occur partially occurs in the particle 1. As a result, precipitation of the Fe phase of a body-centered cubic lattice which is crystallized with relative ease is promoted, and the crystalline phase having the crystallite diameter as described above is easily formed.

A content a of Cu is 0.3 at % or more and 2.0 at % or less, preferably 0.5 at % or more and 1.5 at % or less, and more preferably 0.7 at % or more and 1.3 at % or less. When the content a of Cu is less than the lower limit value, refinement of the crystalline phase is impaired. On the other hand, when the content a of Cu exceeds the upper limit value, the mechanical properties of the soft magnetic powder may be deteriorated and may become brittle.

When Nb (niobium) is subjected to the heat treatment from a state occupied by an amorphous structure, Nb makes a contribution to the refinement of the crystalline phase 3 together with Cu. Therefore, the crystalline phase 3 having the crystallite diameter as described above is easily formed.

A content b of Nb is 2.0 at % or more and 4.0 at % or less, preferably 2.5 at % or more and 3.5 at % or less, and more preferably 2.7 at % or more and 3.3 at % or less. When the content b of Nb is less than the lower limit value, refinement of the crystalline phase 3 is impaired. On the other hand, when the content b of Nb exceeds the upper limit value, the mechanical properties of the soft magnetic powder may be deteriorated and may become brittle. In addition, the magnetic permeability of the soft magnetic powder decreases.

Silicon (Si) promotes amorphization when the soft magnetic powder according to the embodiment is manufactured from a raw material. Therefore, when the soft magnetic powder according to the embodiment is manufactured, a homogeneous amorphous structure is once formed, and thereafter, by crystallizing the amorphous structure, the crystalline phase 3 having a more uniform crystallite diameter is easily formed. Since the uniform crystallite diameter contributes to averaging of the crystal magnetic anisotropy in each crystalline phase 3, the coercive force can be reduced and the magnetic permeability can be increased, which contributes to an improvement of the soft magnetism.

B (boron) promotes amorphization when the soft magnetic powder according to the embodiment is manufactured from a raw material. Therefore, when the soft magnetic powder according to the embodiment is manufactured, a homogeneous amorphous structure is once formed, and thereafter, by crystallizing the amorphous structure, the crystalline phase 3 having a more uniform crystallite diameter is easily formed. As a result, the coercive force can be reduced, the magnetic permeability can be increased, and the soft magnetism can be improved. By using Si and B in combination, the amorphization can be synergistically promoted based on a difference in an atomic radius between Si and B.

Cr (chromium) contributes to stabilization of the amorphous phase 2 by being unevenly distributed in the amorphous phase 2. By stabilizing the amorphous phase 2, coarsening of the crystalline phase 3 is suppressed, and the crystallite diameter is made uniform. This makes it possible to reduce the coercive force of the soft magnetic powder. In addition, Cr increases the oxidation resistance of the soft magnetic powder. Accordingly, when the soft magnetic powder is compressed, it is possible to suppress a decrease in density of the green compact due to the oxide. As a result, it is possible to increase the magnetic permeability and the saturation magnetic flux density measured in the state of the green compact.

Here, the total content (Si+B+Cr) of Si, B, and Cr is set to 1, and the ratio of the total content (B+Cr) of B and Cr to the total content (Si+B+Cr) is set to y.

This ratio y satisfies 0.55≤y≤0.91, preferably satisfies 0.60≤y≤0.90, and more preferably satisfies 0.65≤y≤0.80. Thus, the quantitative balance of Si with B and Cr can be achieved. As a result, it is possible to reduce the coercive force of the soft magnetic powder and to enhance both the oxidation resistance and the magnetic permeability in a balanced manner.

When the ratio y is less than the lower limit value, the amorphous phase 2 becomes unstable and it becomes difficult to reduce the coercive force. In addition, the oxidation resistance decreases, and the crystallite diameter becomes too small, and the magnetic permeability decreases. On the other hand, when the ratio y exceeds the upper limit value, the concentration of Si decreases, and thus the amorphous phase 2 becomes difficult to be formed.

The ratio of the content of Cr to the total content (B+Cr) is defined as z.

The ratio z satisfies 0.015≤z≤0.185, preferably satisfies 0.030≤z≤0.150, and more preferably satisfies 0.045≤z≤0.120. Thus, the quantitative balance between B and Cr can be achieved. As a result, it is possible to enhance both the oxidation resistance and the magnetic permeability in a balanced manner while achieving a reduction of the coercive force of the soft magnetic powder.

When z is below the lower limit value, it is difficult to reduce the coercive force. In addition, the oxidation resistance decreases, and the crystallite diameter becomes too small, and the magnetic permeability decreases. On the other hand, when the ratio z exceeds the upper limit value, the concentration of B decreases, and thus the amorphous phase 2 becomes difficult to be formed.

The content of Si is set to preferably 1.5 at % or more and 14.0 at % or less, more preferably 3.0 at % or more and 10.0 at % or less, further more preferably 4.0 at % or more and 8.0 at % or less. Accordingly, the magnetic permeability of the soft magnetic powder can further be increased and the coercive force can further be reduced.

The content of B is preferably 5.0 at % or more and 17.0 at % or less, more preferably 7.0 at % or more and 16.0 at % or less, and still more preferably 9.0 at % or more and 13.5 at % or less. Accordingly, the magnetic permeability of the soft magnetic powder can further be increased and the coercive force can further be reduced.

The content of Cr is preferably 0.3 at % or more and 2.7 at % or less, more preferably 0.5 at % or more and 2.2 at % or less, still more preferably 0.8 at % or more and 1.8 at % or less. Accordingly, the oxidation resistance of the soft magnetic powder can further be increased, and generation of oxides can be further suppressed. As a result, it is possible to suppress a decrease in density of the green compact due to the oxide, and to further increase the magnetic permeability and the saturation magnetic flux density of the green compact. In addition, the crystallite diameter of the crystalline phase 3 can appropriately be controlled, and the balance between low coercive force and high magnetic permeability can further be optimized.

The soft magnetic powder according to the embodiment may contain impurities in addition to the composition represented by the composition formula FeₓCuₐNb_{b}(Si_{1-y}(B_{1-z}Cr_{z})_{y})_{100-x-a-b}. Examples of the impurity include all elements other than those described above, and a total content of impurities is preferably 0.50 at % or less. As long as the content is within this range, the above effect is hardly inhibited even when the impurities are mixed, and therefore, even an intentionally added element or an inevitably mixed element is allowed to be contained.

The content of each element contained in the impurities is preferably 0.05 at % or less. As long as the content is within this range, the impurities do not easily hinder the above-described effects, and thus the inclusion is allowed.

Among the impurities, in particular, the oxygen content is preferably 1500 ppm or less, and more preferably 800 ppm or less. As long as the oxygen content is within the above range, the generation of the oxides that cause a decrease in the density of the green compact can particularly be suppressed.

Although the soft magnetic powder according to the embodiment is described hereinabove, the above composition and impurities are determined by an optical emission spectrometer (OES). Examples of the optical emission spectrometer include SPECTRO LAB M9 made by SPECTRO, and QSN750 made by OBLF.

The impurities may be detected by the following analysis method as necessary. Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

In particular, when specifying carbon (C) and sulfur (S), an infrared absorption method after combustion in a current of oxygen (combustion in high frequency induction furnace) defined in JIS G 1211:2011 is also used. Specific examples thereof include a carbon-sulfur analyzer CS-200 made by LECO Corporation.

In particular, when nitrogen (N) and oxygen (O) are specified, methods for determination of nitrogen content for an iron and steel defined in JIS G 1228:1997 and general rules for determination of oxygen in metal materials defined in JIS Z 2613:2006 are also used. Specific examples thereof include an oxygen/nitrogen analyzer TC-300/EF-300 made by LECO Corporation, an oxygen/nitrogen/hydrogen analyzer made by LECO Corporation, and ONH836.

### 1.3. Amorphous Phase

The amorphous phase 2 has an amorphous structure in which Fe is an element having the highest concentration. The amorphous phase 2 and the crystalline phase 3 can be distinguished depending on whether B is unevenly distributed. When element mapping analysis by EDX is performed on the cross section of the particle 1, a region in which B is unevenly distributed and a region in which the concentration of B is lower than the region can be distinguished. The former region can be regarded as the amorphous phase 2, and the latter region can be regarded as the crystalline phase 3. The term “uneven distribution” refers to a state in which the concentration of B is higher than that of the surroundings. For example, in the concentration distribution of B acquired by the elemental mapping analysis, a region having a high concentration of B is displayed by color density or the like.

As described above, Cr is unevenly distributed in the amorphous phase 2. Therefore, as described above, Cr is unevenly distributed to stabilize the amorphous phase 2 and suppress coarsening of the crystalline phase 3. In addition, it is conceivable that when Cr is unevenly distributed in the amorphous phase 2, a pinning effect of suppressing the growth of the crystal is generated, and it is also conceivable that coarsening of the crystalline phase 3 can also be suppressed by the pinning effect.

When element analysis by EDX is performed on the cross section of the particle 1, each element concentration of the amorphous phase 2 and the crystalline phase 3 can be obtained. The content Y(Cr) of Cr [at %] of the amorphous phase 2 obtained by EDX satisfies the relationship represented by the following formula (1) with respect to the content X(Cr) of Cr [at %] obtained by OES.

$$\\ \begin{matrix}X ( Cr ) < Y ( Cr ) \leq X ( Cr ) + 1. & ( 1 )\end{matrix}$$

When the content Y(Cr) of Cr in the amorphous phase 2 is less than the lower limit value, it can be said that Cr is not sufficiently unevenly distributed in the amorphous phase 2. In this case, the amorphous phase 2 cannot sufficiently be stabilized, and coarsening of the crystalline phase 3 cannot sufficiently be suppressed. On the other hand, when the content Y(Cr) of Cr in the amorphous phase 2 exceeds the upper limit value, Cr is excessively unevenly distributed in the amorphous phase 2, and the amorphous structure becomes rather unstable.

The lower limit value of the formula (1) is preferably X(Cr)+0.1 or more, more preferably X(Cr)+0.2 or more, and still more preferably 1.5 or more. On the other hand, the upper limit value of the formula (1) is preferably X(Cr)+0.8 or less, more preferably X(Cr)+0.6 or less, and still more preferably 2.5 or less.

The content Y(Cr) of Cr in the amorphous phase 2 is a value obtained by averaging contents of Cr measured at five or more points in the amorphous phase 2 provided in the cross section of the single grain 1.

In the amorphous phase 2, the concentration of B is optimized. Accordingly, the crystallization temperature can be increased, and the amorphous phase 2 is easily formed. That is, B the concentration of which is optimized contributes to stabilization of the amorphous phase 2.

The content Y(B) [at %] of B in the amorphous phase 2 obtained by EDX satisfies the relationship represented by the following formula (2).

3.0≤Y(B)≤15.0 (2)

When the content Y(B) of B in the amorphous phase 2 is less than the lower limit value, it can be said that B is not sufficiently present in the amorphous phase 2. In this case, the amorphous phase 2 cannot sufficiently be stabilized, and coarsening of the crystalline phase 3 cannot sufficiently be suppressed. On the other hand, when the content Y(B) of B in the amorphous phase 2 exceeds the upper limit value, B is excessively present in the amorphous phase 2, and the amorphous structure is rather unstable.

The lower limit value of the formula (2) is preferably 4.0 or more, and more preferably 4.5 or more. On the other hand, the upper limit value of the formula (2) is preferably 10.0 or less, and more preferably 7.0 or less.

The content Y(B) of B in the amorphous phase 2 is a value obtained by averaging contents of B measured at five or more points in the amorphous phase 2 provided in the cross section of the single particle 1.

The content of Fe in the amorphous phase 2 is preferably 50.0 at % or more, more preferably 70.0 at % or more and 95.0 at % or less, and still more preferably 80.0 at % or more and 90.0 at % or less.

Furthermore, the content of Si in the amorphous phase 2 is preferably 2.0 at % or more and 8.0 at % or less, more preferably 3.0 at % or more and 7.0 at % or less, and still more preferably 4.0 at % or more and 6.0 at % or less.

### 1.4. Crystalline Phase

The crystalline phase 3 is formed of a crystalline structure in which Fe is an element having the highest concentration. As represented by the following formula (3), the content Z(Cr) [at %] of Cr in the crystalline phase 3 obtained by EDX preferably satisfies the relationship represented by the following formula (3) with respect to the content X(Cr) of Cr obtained by OES.

Z(Cr)<X(Cr) (3)

Cr is unevenly distributed in the amorphous phase 2, and accordingly, the content of Cr in the crystalline phase 3 tends to decrease. Accordingly, by satisfying the above formula (3), the amorphous phase 2 is further stabilized. When the content Z(Cr) of Cr in the crystalline phase 3 exceeds the upper limit value, there is a possibility that the crystalline phase 3 is not formed of a stable crystalline structure. In this case, it may be difficult to sufficiently increase the magnetic permeability of the soft magnetic powder.

The lower limit value of the formula (3) may not be particularly limited, but is preferably 0.3 or more, more preferably 0.5 or more, and still more preferably 0.8 or more. On the other hand, the upper limit value of the formula (3) is preferably X(Cr)−0.1 or less, more preferably X(Cr)−0.2 or less, and still more preferably 2.0 or less.

The content Z(Cr) of Cr in the crystalline phase 3 is a value obtained by averaging contents of Cr measured at five or more points in the crystalline phase 3 provided in the cross section of the single particle 1.

The content of Fe in the crystalline phase 3 is preferably 50.0 at % or more, more preferably 70.0 at % or more and 95.0 at % or less, and still more preferably 80.0 at % or more and 90.0 at % or less.

The content of Si in the crystalline phase 3 is preferably 3 at % or more and 9 at % or less, more preferably 4 at % or more and 8 at % or less, and still more preferably 5 at % or more and 7 at % or less.

Although the amorphous phase 2 and the crystalline phase 3 have been described above, each of the above contents is determined by the energy dispersive X-ray fluorescence spectrometer (EDX). Examples of the energy dispersive X-ray fluorescence spectrometer include NSS7 made by ThermoFisher Scientific Corporation. An acceleration voltage at the time of analysis is set to 120 kV, and Cliff-Lorimer (MBTS) that does not take absorption correction into account is used in the quantification method using the EDX spectrum.

### 1.5. Crystallite Diameter

In the soft magnetic powder according to the embodiment, the crystallite diameter measured by X-ray diffraction is preferably 20.0 nm or less, more preferably 3.0 nm or more and 15.0 nm or less, and still more preferably 6.0 nm or more and 13.0 nm or less. When the crystallite diameter is within such a range, since the crystallite diameter of the soft magnetic powder is optimized, the magnetic permeability of the soft magnetic powder can be increased. In addition, the crystal magnetic anisotropy in each crystalline phase 3 is easily averaged, and a soft magnetic powder low in coercive force is obtained. Furthermore, as the magnetic permeability increases, the soft magnetic powder is less likely to be saturated even under a high current, and thus the saturation magnetic flux density of the soft magnetic powder is easily increased.

The measurement of the crystallite diameter by the X-ray diffraction method is performed by a method in which an X-ray diffraction pattern is obtained for each of the soft magnetic powder and a standard sample, the diffraction line width derived from Fe is estimated, and then the crystallite diameter is calculated by the Scherrer method. The X-ray diffraction pattern obtained for the standard sample is used to estimate the diffraction line width derived from an apparatus. The crystallite diameter calculated from the soft magnetic powder (test sample) can be corrected with the diffraction line width.

### 1.6. Various Characteristics

The average particle size of the soft magnetic powder according to the embodiment is not particularly limited, but is preferably 1 μm or more and 50 μm or less, more preferably 10 μm or more and 45 μm or less, and still more preferably 20 μm or more and 40 μm or less. By using the soft magnetic powder having such an average grain size, it is possible to shorten a path through which an eddy current flows, and thus it is possible to manufacture a magnetic element capable of sufficiently reducing an eddy current loss occurred in the particles of the soft magnetic powder. In addition, the filling rate of the soft magnetic powder in the green compact can be increased, and the magnetic permeability and saturation magnetic flux density of the powder magnetic core can be increased.

When the soft magnetic powder has an average particle size of 10 μm or more, a higher green compact density can be achieved by mixing the soft magnetic powder having an average particle size smaller than that of the soft magnetic powder according to the embodiment with the soft magnetic powder according to the embodiment. This makes it easier to increase the saturation magnetic flux density and the magnetic permeability of the powder magnetic core.

The average particle size of the soft magnetic powder refers to a particle size D50 in which the cumulative frequency is 50% from the small diameter side in the cumulative particle size distribution on a volume basis of the soft magnetic powder obtained using a laser diffraction type particle size distribution measuring apparatus.

When the average grain size of the soft magnetic powder is less than the above lower limit value, the soft magnetic powder is too fine, and thus filling properties of the soft magnetic powder may easily decrease. As a result, since the formation density of the powder magnetic core decreases, the magnetic permeability and saturation magnetic flux density of the powder magnetic core may decrease depending on the composition and mechanical properties of the soft magnetic powder. On the other hand, when the average grain size of the soft magnetic powder exceeds the above upper limit value, depending on the composition and the mechanical properties of the soft magnetic powder, the eddy current loss occurred in the particles cannot be sufficiently reduced, and the iron loss of the magnetic element may increase.

The coercive force of the soft magnetic powder according to the embodiment is not particularly limited, but is preferably less than 2.00 [Oe] (less than 160 [A/m]), more preferably 0.10 [Oe] or more and 1.67 [Oe] or less (39.9 [A/m] or more and 133 [A/m] or less), and still more preferably 0.10 [Oe] or more and 1.00 [Oe] or less (39.9 [A/m] or more and 79.6 [A/m] or less). By using the soft magnetic powder having such a small coercive force, it is possible to manufacture a magnetic element capable of sufficiently reducing a hysteresis loss even under a high frequency. The coercive force may be lower than the lower limit value, but the degree of difficulty in manufacturing may increase.

The coercive force of the soft magnetic powder can be measured, for example, by a vibrating sample magnetometer such as TM-VSM1230-MHHL manufactured by Tamakawa Co., Ltd.

When the soft magnetic powder according to the embodiment is formed as a green compact, the magnetic permeability thereof is preferably 24.0 or more and more preferably 25.0 or more at a measurement frequency of 1 MHz. Such soft magnetic powder has excellent DC superimposition characteristics, has high electromagnetic conversion efficiency at high frequencies, and contributes to the realization of a magnetic element that is downsized. The magnetic permeability is measured in a state in which the soft magnetic powder is compressed together with the epoxy resin added to the soft magnetic powder at a ratio of 2 mass % at a molding pressure of 294 MPa (3 t/cm²) to form a ring-shaped body having an outer diameter of 14 mm, an inner diameter of 8 mm, and a thickness of 3 mm, and then a conductive wire having a wire diameter of 0.6 mm is wound around the ring-shaped green compact seven times. For the measurement of the magnetic permeability, for example, an impedance analyzer such as 4194A made by Agilent Technologies, Inc. is used. The measurement frequency is set to 1 MHz.

The saturation magnetic flux density of the soft magnetic powder according to the embodiment is preferably 1.25 [T] or more, and more preferably 1.30 [T] or more. Thus, a magnetic element that is less likely to be saturated even with a high current is obtained.

The saturation magnetic flux density of the soft magnetic powder is measured by, for example, the following method.

First, a true specific gravity p of the soft magnetic powder is measured by a full-automatic gas substitution type densitometer AccuPyc 1330 manufactured by Micromeritics Corporation. Next, a maximum magnetization Mm of the soft magnetic powder is measured by a vibrating sample magnetometer, VSM system, TM-VSM1230-MHHL manufactured by Tamakawa Co., Ltd. Then, the saturation magnetic flux density Bs is calculated by the following equation.

$$\\ Bs = 4 π / 10000 \times ρ \times Mm$$

The soft magnetic powder according to the embodiment is mixed with epoxy resin at 2 mass %, and the density of a green compact obtained by pressure-molding the mixture thus obtained at pressure of 294 MPa is preferably 4.99 g/cm³ or more, and more preferably 5.01 g/cm³ or more and 5.20 g/cm³ or less. When the density of the green compact is within the above range, the occupancy of the oxide in the green compact is sufficiently suppressed, and as a result, the occupancy of the alloy can sufficiently be ensured. This can further increase the magnetic permeability and the saturation magnetic flux density of the magnetic element.

The soft magnetic powder according to the embodiment may be mixed with other soft magnetic powder or non-soft magnetic powder, and the mixed powder may be used for various applications.

### 2. Method of Manufacturing Soft Magnetic Powder

Next, an example of a method for manufacturing the above soft magnetic powder will be described.

The soft magnetic powder may be a powder manufactured by any methods. Examples of the method for manufacturing the soft magnetic powder include, in addition to various atomization methods such as a water atomization method, a gas atomization method, and a rotary water atomization method, a pulverization method. Among these, the atomization method is preferably used. According to the atomization method, it is possible to efficiently manufacture a high-quality metal powder having a particle shape close to a true sphere and having less formation of an oxide or the like. Therefore, a metal powder having a small specific surface area can be manufactured by the atomization method.

The atomization method is a method for manufacturing a metal powder by causing a molten metal to collide with a liquid or a gas ejected at a high speed so as to pulverize and cool the molten metal. In the atomization method, since the spheroidizing is performed in the process of solidification after the molten metal is micronized, particles close to a true sphere can be manufactured.

Among them, the water atomization method is a method for manufacturing a metal powder from a molten metal by using a liquid such as water as a cooling liquid, spraying the liquid in an inverted conical shape that converges the liquid to one point, and causing the molten metal to flow down toward the convergence point and to collide with the liquid.

In addition, the rotary water atomization method is a method for manufacturing a metal powder by supplying a cooling liquid along an inner peripheral surface of a cooling cylinder, swirling the cooling liquid along the inner peripheral surface, spraying a jet of a liquid or a gas to a molten metal, and merging the scattered molten metal into the cooling liquid.

Further, the gas atomization method is a method for manufacturing a metal powder from a molten metal by using a gas as a cooling medium, injecting the gas in an inverted conical shape that converges the gas to one point, and causing the molten metal to flow down toward the convergence point and collide with the gas.

Each of the particles of the metal powder obtained in such a manner has an amorphous structure. By performing the crystallization treatment (heat treatment) on such a metal powder, a part of the amorphous structure is crystallized. Thus, the soft magnetic powder containing the amorphous phase 2 and the crystalline phase 3 described above is obtained.

The temperature of the crystallization treatment is not particularly limited, but is preferably 520° C. or more and 640° C. or less, more preferably 530° C. or more and 630° C. or less, and still more preferably 540° C. or more and 620° C. or less. A time in the heat treatment, which is a time for maintaining the above temperature, is preferably 1 minute or longer and 180 minutes or shorter, more preferably 3 minutes or longer and 120 minutes or shorter, and still more preferably 5 minutes or longer and 60 minutes or shorter. By setting the temperature and the duration of the heat treatment within the respective ranges, the crystalline phase 3 having a suitable range and a uniform crystallite diameter can be generated.

When the temperature or the duration of the heat treatment is less than the lower limit value, the crystallization may become insufficient depending on the composition or the like of the soft magnetic powder, resulting in an excessively small crystallite diameter or poor uniformity of the crystallite diameter. On the other hand, when the temperature or the duration of the heat treatment exceeds the upper limit value, the crystallization may proceed excessively depending on the composition or the like of the soft magnetic powder, and the crystallite diameter may become excessive or the uniformity of the crystallite diameter may be deteriorated.

An atmosphere in the crystallization treatment is not particularly limited, and is preferably an inert gas atmosphere such as nitrogen or argon, a reducing gas atmosphere such as hydrogen or ammonia decomposition gas, or a reduced-pressure atmosphere thereof. According to this, crystallization can be achieved while suppressing oxidation of the metal, and thus, a soft magnetic powder having excellent magnetic properties is obtained.

The oxygen concentration in the atmosphere of the crystallization treatment affects the amount of oxides manufactured. The oxygen concentration in the crystallization treatment atmosphere is preferably 1000 ppm or less, more preferably 5 ppm or more and 500 ppm or less, and still more preferably 10 ppm or more and 200 ppm or less in terms of volume ratio. As a result, generation of oxides can be suppressed, and the soft magnetic powder capable of manufacturing a high-density green compact can be obtained.

The temperature rising rate in the crystallization treatment is preferably 1° C./min or more and 80° C./min or less, more preferably 2° C./min or more and 30° C./min or less, and still more preferably 4° C./min or more and 20° C./min or less. By setting the temperature rising rate within the above range, even when a large amount of metal powder is subjected to the crystallization treatment, unevenness in the temperature rising rate is suppressed, the crystallite diameter of the soft magnetic powder is easily controlled within the above range, and a variation in the crystallite diameter can be suppressed. When the temperature rising rate is lower than the lower limit value, the efficiency of the crystallization treatment decreases, and the production efficiency of the soft magnetic powder may decrease. On the other hand, when the temperature rising rate exceeds the upper limit value, when a large amount of metal powder is subjected to the crystallization treatment, the variation in crystallite diameter of the soft magnetic powder becomes large, and the coercive force of the soft magnetic powder may increase.

The temperature dropping rate in the crystallization treatment is not particularly limited, but is preferably 1° C./min or more and 100° C./min or less, more preferably 2° C./min or more and 30° C./min or less, and still more preferably 4° C./min or more and 20° C./min or less. By setting the temperature dropping rate within the above range, it becomes easier to control the crystallite diameter of the soft magnetic powder within the above range. In addition, the variation in crystallite diameter is more easily suppressed.

In this manner, the soft magnetic powder according to this embodiment can be produced. The soft magnetic powder manufactured may be classified as necessary. Examples of classification methods include dry classification such as sieving classification, inertial classification, and centrifugal classification, and wet classification such as sedimentation classification.

Further, an insulating film may be formed on the surface of each particle of the thus obtained soft magnetic powder as needed. Examples of a constituent material of the insulating film include inorganic materials such as phosphates such as magnesium phosphate, calcium phosphate, zinc phosphate, manganese phosphate, and cadmium phosphate, and silicates such as sodium silicate, ceramic materials such as silica, alumina, magnesia, zirconia, and titania, and glass materials such as borosilicate glass and silica glass.

### 3. Magnetic Powder Core and Magnetic Element

Next, a magnetic powder core and a magnetic element according to the embodiment will be described.

The magnetic element according to the embodiment can be applied to various magnetic elements including a magnetic core, such as a choke coil, an inductor, a noise filter, a reactor, a transformer, a motor, an actuator, an electromagnetic valve, and a generator. The magnetic powder core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is an example of the magnetic element according to the embodiment, will be described.

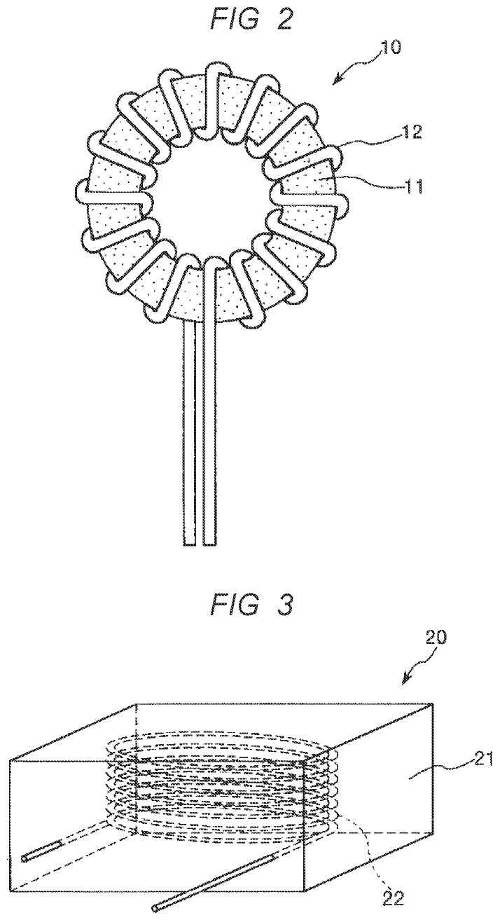

FIG. 2 is a plan view schematically illustrating a toroidal type coil component 10.

The coil component 10 shown in FIG. 2 includes a ring-shaped magnetic powder core 11 and a conductive wire 12 wound around the magnetic powder core 11.

The magnetic powder core 11 is obtained by mixing the soft magnetic powder according to the embodiment and a binder, supplying the obtained mixture to a mold, and pressing and molding the mixture. That is, the magnetic powder core 11 is a green compact containing the soft magnetic powder according to the embodiment. Such the powder magnetic core 11 has the high molding density and the high magnetic permeability. Therefore, when the coil component 10 having the powder magnetic core 11 is mounted on an electronic device or the like, high performance and miniaturization of the electronic device or the like can be achieved. The binder may be added as necessary, and may be omitted.

In addition, in the coil component 10 as the magnetic element including such the powder magnetic core 11, the loss is reduced and the size is reduced according to the reduction in the coercive force and the increase in the magnetic permeability of the powder magnetic core 11.

Examples of a constituent material of the binder used for producing the magnetic powder core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate. In particular, the constituent material of the binder is preferably a thermosetting polyimide or an epoxy-based resin. The resin materials are easily cured by being heated and have excellent heat resistance. Therefore, ease of manufacturing the magnetic powder core 11 and heat resistance thereof can be improved.

A proportion of the binder with respect to the soft magnetic powder slightly varies depending on a target saturation magnetic flux density and mechanical properties of the dust core 11 to be prepared, an acceptable eddy current loss, or the like, and is preferably about 0.5 mass % or more and 5 mass % or less, and more preferably about 1 mass % or more and 3 mass % or less. Accordingly, it is possible to obtain the dust core 11 having excellent magnetic properties such as the saturation magnetic flux density and the magnetic permeability while sufficiently binding the particles of the soft magnetic powder to each other. Various additives may be added to the mixture as necessary for any purpose.

Examples of a constituent material of the conductive wire 12 include a material having high conductivity, for example, a metal material including Cu, Al, Ag, Au, and Ni. An insulating film is provided on a surface of the conductive wire 12 as necessary.

A shape of the dust core 11 is not limited to the ring shape shown in FIG. 2, and may be, for example, a shape in which a part of the ring is missing, or a shape in which a shape in a longitudinal direction is linear.

The dust core 11 may contain, as necessary, a soft magnetic powder other than the soft magnetic powder according to the embodiment described above, or a non-magnetic powder.

### 3.2. Closed Magnetic Circuit Type

Next, a closed magnetic circuit type coil component, which is an example of the magnetic element according to the embodiment, will be described.

FIG. 3 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

As shown in FIG. 3, the coil component 20 according to the embodiment is formed by embedding a conductive wire 22 formed in a coil shape inside a magnetic powder core 21. That is, the coil component 20 is formed by molding the conductive wire 22 with the powder magnetic core 21. The magnetic powder core 21 has the same configuration as that of the magnetic powder core 11 described above.

The coil component 20 in such a form can easily be obtained in a relatively small size. Then, the coil component 20 in which the loss is reduced and the size is reduced according to the reduction in the coercive force and the increase in the magnetic permeability of the powder magnetic core 21 is obtained.

Since the conductive wire 22 is embedded in the magnetic powder core 21, a gap is less likely to be formed between the conductive wire 22 and the magnetic powder core 21. Therefore, vibration caused by magnetostriction of the magnetic powder core 21 can be prevented, and generation of noise due to the vibration can also be prevented.

The magnetic powder core 21 may contain, as necessary, a soft magnetic powder other than the soft magnetic powder according to the embodiment described above or a non-magnetic powder.

### 4. Electronic Device

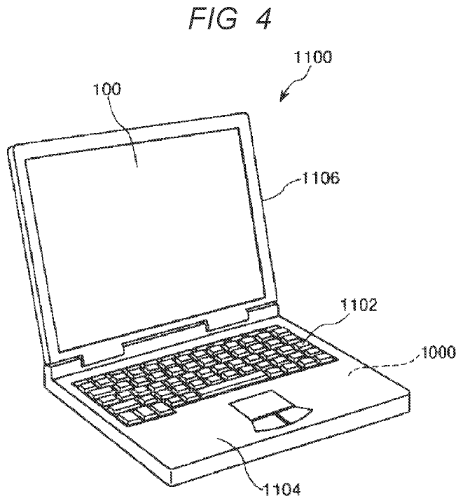

Next, an electronic device including the magnetic element according to the embodiment will be described with reference to FIGS. 4 to 6.

FIG. 4 is a perspective view illustrating a configuration of a mobile personal computer 1100 which is an electronic device including the magnetic element 1000 according to the embodiment. The personal computer 1100 shown in FIG. 4 includes a main body 1104 including a keyboard 1102 and a display unit 1106 including a display 100. The display unit 1106 is rotatably supported by the main body 1104 via a hinge structure. Such the personal computer 1100 includes therein the magnetic element 1000 such as a choke coil, an inductor, or a motor for a switching power supply.

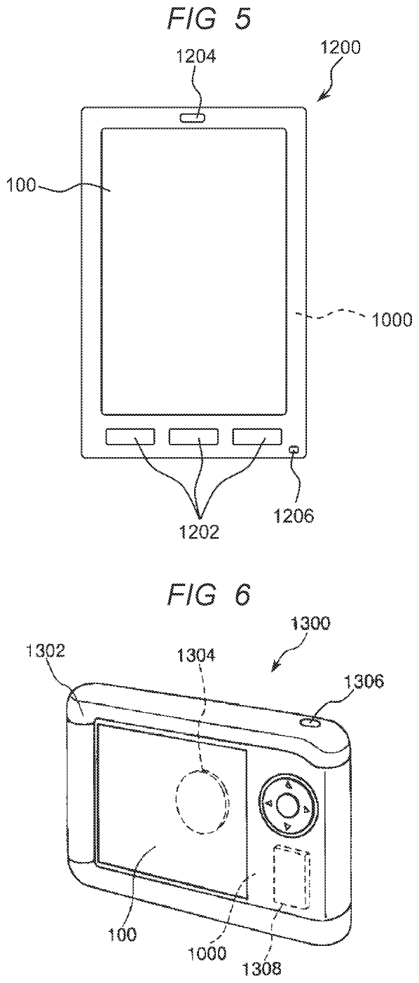

FIG. 5 is a plan view showing a configuration of a smartphone 1200 which is an electronic device including the magnetic element 1000 according to the embodiment. The smartphone 1200 shown in FIG. 5 includes a plurality of operation buttons 1202, an earpiece 1204, and a mouthpiece 1206. The display 100 is disposed between the operation buttons 1202 and the earpiece 1204. Such the smartphone 1200 includes therein the magnetic element 1000 such as an inductor, a noise filter, or a motor.

FIG. 6 is a perspective view showing a configuration of a digital still camera 1300 which is an electronic device including the magnetic element 1000 according to the embodiment. The digital still camera 1300 photoelectrically converts an optical image of a subject by an imaging element such as a charge coupled device (CCD) so as to generate an imaging signal.

The digital still camera 1300 shown in FIG. 6 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such the digital still camera 1300 also includes therein the magnetic element 1000 such as an inductor or a noise filter.

Examples of the electronic device according to the embodiment include, in addition to the personal computer 1100 in FIG. 4, the smartphone 1200 in FIG. 5, and the digital still camera 1300 in FIG. 6, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

Such an electronic device includes the magnetic element according to the embodiment. Accordingly, it is possible to enjoy the advantages of the magnetic element of being low in loss and small in size, and to achieve power saving and a reduction in size of the electronic device.

### 5. Advantages Exerted by Soft Magnetic Powder According to Embodiment

As described above, in the soft magnetic powder according to the present embodiment, the composition determined by the optical emission spectrometer (OES) represents the composition formula in an atomic number ratio FeₓCuₐNb_{b}(Si_{1-y}(B_{1-z}Cr_{z})_{y})_{100-x-a-b} [where a, b, x, y, and z satisfy

$$\\ 0.3 \leq a \leq 2. , 2. \leq b \leq 4. , 75.5 \leq x \leq 79.5 , 0.55 \leq y \leq 0.91 , and$$

$$\\ 0.015 \leq z \leq 0.185 ] .$$

The soft magnetic powder according to the present embodiment has the amorphous phase 2 having the amorphous structure in which Fe is the element having the highest concentration, and the crystalline phase 3 having the crystalline structure in which Fe is the element having the highest concentration.

Defining the content [at %] of Cr determined by the optical emission spectrometer (OES) as X(Cr), and the content [at %] of Cr and the content [at %] of B in the amorphous phase 2 determined by the energy dispersive X-ray fluorescence spectrometer (EDX) as Y(Cr) and Y(B), the soft magnetic powder according to the present embodiment satisfies the following formulas (1) and (2).

$$\\ \begin{matrix}X ( Cr ) < Y ( Cr ) \leq X ( Cr ) + 1. & ( 1 )\end{matrix}$$

$$\\ \begin{matrix}3. \leq Y ( B ) \leq 15. & ( 2 )\end{matrix}$$

According to such a configuration, since the soft magnetic powder is excellent in oxidation resistance, it is possible to obtain the soft magnetic powder with which a green compact high in density and high in magnetic permeability can be manufactured. In addition, the amorphous phase 2 can be stabilized, and coarsening of the crystalline phase 3 in the crystallization treatment can be suppressed regardless of the conditions of the heat treatment, and therefore the soft magnetic powder low in coercive force and easy to manufacture is obtained.

The soft magnetic powder according to the present embodiment preferably satisfies the following formula (3), defining the content [at %] of Cr in the crystalline phase 3 determined by an energy dispersive X-ray fluorescence spectrometer (EDX) as Z(Cr).

$$\\ \begin{matrix}Z ( Cr ) < X ( Cr ) & ( 3 )\end{matrix}$$

In the soft magnetic powder according to the present embodiment, the content Y(B) [at %] of B in the amorphous phase 2 determined by the energy dispersive X-ray fluorescence spectrometer (EDX) preferably satisfies the following formula (4).

$$\\ \begin{matrix}3. \leq Y ( B ) \leq 10. & ( 4 )\end{matrix}$$

According to such a configuration, the content Z(Cr) of Cr in the crystalline phase 3 and the content Y(B) of B in the amorphous phase 2 are respectively optimized, and the amorphous phase 2 can further be stabilized.

In addition, Y(Cr) [at %], Y(B) [at %], and the content Z(Cr) [at %] of Cr preferably satisfy the following formulas (5) to (7).

$$\\ \begin{matrix}1.5 \leq Y ( Cr ) \leq 2.5 & ( 5 )\end{matrix}$$

$$\\ \begin{matrix}4. \leq Y ( B ) \leq 7. & ( 6 )\end{matrix}$$

$$\\ \begin{matrix}0.8 \leq Z ( Cr ) \leq 2. & ( 7 )\end{matrix}$$

According to such a configuration, the content of Cr and the content of B in the amorphous phase 2 and the content of Cr in the crystalline phase 3 are respectively optimized, and further stabilization of the amorphous phase 2 can be achieved.

The oxygen content in the soft magnetic powder is preferably 1500 ppm or less. As a result, it is possible to suppress the generation of oxides that cause a decrease in density of the green compact.

The powder magnetic core according to the embodiment includes the soft magnetic powder according to the embodiment. As a result, it is possible to obtain a powder magnetic core having a low coercive force and a high magnetic permeability.

The magnetic element according to the embodiment includes the powder magnetic core according to the embodiment. Thus, the magnetic element reduced in loss and reduced in size can be obtained.

The electronic device according to the embodiment includes the magnetic element according to the embodiment. As a result, the electronic device that achieves power saving and a reduction in size can be obtained.

The soft magnetic powder, the powder magnetic core, the magnetic element, and the electronic device of the present disclosure are described hereinabove based on the preferred embodiments, but the present disclosure is not limited thereto.

For example, in the embodiment described above, as an application example of the soft magnetic powder of the present disclosure, a green compact such as a powder magnetic core is described, but the application example is not limited thereto, and for example, a magnetic device such as a magnetic fluid, a magnetic sticky elastomer composition, a magnetic head, an electromagnetic wave shielding member, or a magnetic core of an electric motor or a generator may be adopted.

In addition, the soft magnetic powder, the powder magnetic core, the magnetic element, and the electronic device of the present disclosure may be obtained by adding any components to the above-described embodiment.

Furthermore, the shapes of the powder magnetic core and the magnetic element are not limited to those shown in the drawings, and any shapes may be adopted.

### EXAMPLES

Next, specific examples of the present disclosure will be described.

### 6. Manufacture of Green Compact

### 6.1. Sample No. 1

First, a raw material was melted in a high-frequency induction furnace and pulverized by the rotary water atomization method to obtain a metal powder.

Then, the metal powder thus obtained was subjected to the crystallization treatment of performing heating in a nitrogen atmosphere. Thus, the soft magnetic powder was obtained. The heating temperature and the temperature rising rate in the crystallization treatment are as shown in Table 1. The temperature dropping rate after heating was 10° C./min. The heating temperature shown in Table 1 is a value obtained in advance by searching for the heating temperature at which the coercive force of each soft magnetic powder is minimized.

Subsequently, the soft magnetic powder was classified by a wind classifier. Subsequently, the soft magnetic powder after classification was subjected to composition analysis by an optical emission spectrometer (OES). The analysis results are shown in Table 1.

Subsequently, the soft magnetic powder thus obtained was subjected to particle size distribution measurement. The average particle size of the soft magnetic powder obtained from the particle size distribution was 20 μm.

Subsequently, the soft magnetic powder thus obtained and epoxy resin as a binder were mixed with each other to obtain a mixture. The addition amount of the epoxy resin was 2 parts by mass (2 mass % of the soft magnetic powder) with respect to 100 parts by mass of the soft magnetic powder.

Then, the mixture thus obtained was stirred and then dried for a short time to obtain a massive dried body. Next, the dried body was sieved with a sieve having an opening of 600 μm, and the dried body was pulverized to obtain granulated powders. The obtained granulated powders were dried at 50° C. for 1 hour.

Then, the obtained granulated powder was made to fill a molding die to be formed under the following molding conditions, and the binder was cured under the following curing conditions to obtain a green compact.

### Molding Conditions

Forming method: press forming
Shape of green compact: ring shape
Dimensions of green compact: outer diameter 14 mm, inner diameter 8 mm, thickness 3 mm
Molding pressure: 3 t/cm² (294 MPa)

### Curing Conditions of Binder

Heating temperature: 150° C.
Heating time: 0.5 hour
Heating atmosphere: air

### 6.2. Sample Nos. 2 to 21

The soft magnetic powder and the green compact were obtained in the same manner as in Sample No. 1 except that the manufacturing conditions of the soft magnetic powder were changed as shown in Tables 1 and 2.

TABLE 1

| | | | Composition Obtained by OES | | | | | | | | |
|---|---|---|---|---|---|---|---|---|---|---|---|
| | | | | | | | | | | (B + Cr)/ | Cr/ |
| | | Type of | Fe | Cu | Nb | | | Cr | | (Si + B + Cr) | (B + Cr) |
| Sample | | Atomizing | x | a | b | Si | B | X(Cr) | Total | y | Z |
| No. | Classification | Method | at % | | | | | | | — | — |
| No. 1 | Comparative | Rotary | 70.7 | 0.8 | 5.0 | 15.0 | 8.0 | 0.5 | 100.0 | 0.36 | 0.059 |
| | Example | water | | | | | | | | | |
| No. 2 | Examples | Rotary | 76.0 | 1.0 | 3.0 | 8.0 | 10.8 | 1.2 | 100.0 | 0.60 | 0.100 |
| | | water | | | | | | | | | |
| No. 3 | Comparative | Rotary | 77.0 | 1.0 | 3.0 | 5.7 | 13.2 | 0.1 | 100.0 | 0.70 | 0.008 |
| | Example | water | | | | | | | | | |
| No. 4 | Examples | Rotary | 77.0 | 1.0 | 3.0 | 5.7 | 13.0 | 0.3 | 100.0 | 0.70 | 0.023 |
| | | water | | | | | | | | | |
| No. 5 | Examples | Rotary | 77.0 | 1.0 | 3.0 | 5.7 | 12.8 | 0.5 | 100.0 | 0.70 | 0.038 |
| | | water | | | | | | | | | |
| No. 6 | Examples | Rotary | 77.0 | 1.0 | 3.0 | 5.7 | 12.3 | 1.0 | 100.0 | 0.70 | 0.075 |
| | | water | | | | | | | | | |
| No. 7 | Examples | Rotary | 77.0 | 1.0 | 3.0 | 5.7 | 11.8 | 1.5 | 100.0 | 0.70 | 0.113 |
| | | water | | | | | | | | | |
| No. 8 | Examples | Rotary | 77.0 | 1.0 | 3.0 | 5.7 | 11.3 | 2.0 | 100.0 | 0.70 | 0.150 |
| | | water | | | | | | | | | |
| No. 9 | Examples | Rotary | 77.0 | 1.0 | 3.0 | 5.7 | 10.9 | 2.4 | 100.0 | 0.70 | 0.180 |
| | | water | | | | | | | | | |
| No. 10 | Comparative | Rotary | 77.0 | 1.0 | 3.0 | 5.7 | 10.3 | 3.0 | 100.0 | 0.70 | 0.226 |
| | Example | water | | | | | | | | | |
| No. 11 | Comparative | Rotary | 77.0 | 1.0 | 3.0 | 1.5 | 16.5 | 1.0 | 100.0 | 0.92 | 0.057 |
| | Example | water | | | | | | | | | |
| No. 12 | Examples | Rotary | 78.0 | 1.2 | 2.7 | 4.5 | 12.1 | 1.5 | 100.0 | 0.75 | 0.110 |
| | | water | | | | | | | | | |
| No. 13 | Examples | Rotary | 78.0 | 1.0 | 3.0 | 1.8 | 14.7 | 1.5 | 100.0 | 0.90 | 0.093 |
| | | water | | | | | | | | | |
| No. 14 | Examples | Rotary | 79.0 | 0.8 | 3.5 | 1.7 | 13.8 | 1.2 | 100.0 | 0.90 | 0.080 |
| | | water | | | | | | | | | |
| No. 15 | Comparative | Rotary | 80.0 | 1.0 | 3.0 | 1.6 | 13.4 | 1.0 | 100.0 | 0.90 | 0.069 |
| | Example | water | | | | | | | | | |

| | | | | | | Structure of | Heat Treatment | |
|---|---|---|---|---|---|---|---|---|
| | | Composition Obtained by EDX | | | | Metal Powder | Heating | Temperature |
| Sample | | Y(Cr) | Y(B) | Evaluation | Z(Cr) | Before Heat | Temperature | Rising Rate |
| No. | Classification | at % | | — | at % | Treatment | ° C. | ° C./min |
| No. 1 | Comparative | 0.6 | 3.7 | OK | 0.4 | Non- | 580 | 10 |
| | Example | | | | | Crystalline | | |
| No. 2 | Examples | 1.5 | 5.0 | OK | 1.0 | Non- | 610 | 10 |
| | | | | | | Crystalline | | |
| No. 3 | Comparative | 0.1 | 6.2 | NG | 0.1 | Non- | 570 | 10 |
| | Example | | | | | Crystalline | | |
| No. 4 | Examples | 0.4 | 6.1 | OK | 0.2 | Non- | 580 | 10 |
| | | | | | | Crystalline | | |
| No. 5 | Examples | 0.6 | 6.0 | OK | 0.4 | Non- | 590 | 10 |
| | | | | | | Crystalline | | |
| No. 6 | Examples | 1.3 | 5.7 | OK | 0.8 | Non- | 600 | 10 |
| | | | | | | Crystalline | | |
| No. 7 | Examples | 1.9 | 5.5 | OK | 1.2 | Non- | 610 | 10 |
| | | | | | | Crystalline | | |
| No. 8 | Examples | 2.5 | 5.3 | OK | 1.6 | Non- | 600 | 10 |
| | | | | | | Crystalline | | |
| No. 9 | Examples | 3.0 | 5.1 | OK | 1.9 | Non- | 590 | 10 |
| | | | | | | Crystalline | | |
| No. 10 | Comparative | 3.8 | 4.8 | OK | 2.4 | Non- | 570 | 10 |
| | Example | | | | | Crystalline | | |
| No. 11 | Comparative | 1.3 | 7.7 | OK | 0.8 | Non- | 570 | 10 |
| | Example | | | | | Crystalline | | |
| No. 12 | Examples | 1.9 | 5.6 | OK | 1.2 | Non- | 610 | 10 |
| | | | | | | Crystalline | | |
| No. 13 | Examples | 1.9 | 6.9 | OK | 1.2 | Non- | 610 | 10 |
| | | | | | | Crystalline | | |
| No. 14 | Examples | 1.5 | 6.4 | OK | 1.0 | Non- | 600 | 10 |
| | | | | | | Crystalline | | |
| No. 15 | Comparative | 1.3 | 6.2 | OK | 0.8 | CRYSTAL | 600 | 10 |
| | Example | | | | | | | |

TABLE 2

| | | | Composition Obtained by OES | | | | | | | | |
|---|---|---|---|---|---|---|---|---|---|---|---|
| | | | | | | | | | | (B + Cr)/ | Cr/ |
| | | Type of | Fe | Cu | Nb | | | Cr | | (Si + B + Cr) | (B + Cr) |
| Sample | | Atomizing | x | a | b | Si | B | X(Cr) | Total | y | z |
| No. | Classification | Method | at % | | | | | | | — | — |
| No. 16 | Examples | Rotary | 77.0 | 1.0 | 3.0 | 5.7 | 11.8 | 1.5 | 100.0 | 0.70 | 0.113 |
| | | water | | | | | | | | | |
| No. 17 | Examples | Rotary | 77.0 | 1.0 | 3.0 | 5.7 | 11.8 | 1.5 | 100.0 | 0.70 | 0.113 |
| | | water | | | | | | | | | |
| No. 18 | Examples | Rotary | 77.0 | 1.0 | 3.0 | 5.7 | 11.8 | 1.5 | 100.0 | 0.70 | 0.113 |
| | | water | | | | | | | | | |
| No. 19 | Examples | Rotary | 77.0 | 1.0 | 3.0 | 5.7 | 11.8 | 1.5 | 100.0 | 0.70 | 0.113 |
| | | water | | | | | | | | | |
| No. 20 | Examples | Rotary | 77.0 | 1.0 | 3.0 | 5.7 | 11.8 | 1.5 | 100.0 | 0.70 | 0.113 |
| | | water | | | | | | | | | |
| No. 21 | Comparative | Rotary | 77.0 | 1.0 | 3.0 | 5.7 | 11.8 | 1.5 | 100.0 | 0.70 | 0.113 |
| | Example | water | | | | | | | | | |

| | | | | | | Structure of | Heat Treatment | |
|---|---|---|---|---|---|---|---|---|
| | | Composition Obtained by EDX | | | | Metal Powder | Heating | Rising Rate |
| Sample | | Y(Cr) | Y(B) | Evaluation | Z(Cr) | Before Heat | Temperature | Temperature |
| No. | Classification | at % | | — | at % | Treatment | ° C. | ° C./min |
| No. 16 | Examples | 2.0 | 5.6 | OK | 1.1 | Non- | 610 | 3 |
| | | | | | | Crystalline | | |
| No. 17 | Examples | 1.9 | 5.5 | OK | 1.2 | Non- | 610 | 20 |
| | | | | | | Crystalline | | |
| No. 18 | Examples | 1.9 | 5.4 | OK | 1.2 | Non- | 610 | 40 |
| | | | | | | Crystalline | | |
| No. 19 | Examples | 1.9 | 5.3 | OK | 1.2 | Non- | 610 | 56 |
| | | | | | | Crystalline | | |
| No. 20 | Examples | 1.8 | 5.2 | OK | 1.3 | Non- | 610 | 80 |
| | | | | | | Crystalline | | |
| No. 21 | Comparative | 1.6 | 2.5 | NG | 1.5 | Non- | 500 | 56 |
| | Example | | | | | Crystalline | | |

In Tables 1 and 2, among the soft magnetic powders of the respective sample numbers, those corresponding to the present disclosure are classified as “Example,” and those not corresponding to the present disclosure are classified as “Comparative Example.”

### 7. Evaluation of Soft Magnetic Powder and Green Compact (Powder Magnetic Core)

### 7.1. Crystallite Diameter of Soft Magnetic Powder

The crystallite diameter of the soft magnetic powder of each of Examples and Comparative Examples was measured by X-ray diffraction. The measurement results are shown in Tables 3 and 4.

### 7.2. Oxygen Content of Soft Magnetic Powder

The oxygen content of the soft magnetic powder of each of Examples and Comparative Examples was measured. The oxygen content was measured using an oxygen/nitrogen/hydrogen analyzer ONH836 made by LECO Corporation. The measurement results are shown in Tables 3 and 4.

### 7.3. Density of Green Compact

The density of the green compact manufactured using the soft magnetic powder of each of Examples and Comparative Examples was measured. The density of the green compact thus measured was evaluated in light of the following evaluation criteria. The measurement results are shown in Tables 3 and 4.
A: The density of the green compact is 5.01 g/cm³ or more.
B: The density of the green compact is 4.99 g/cm³ or more and less than 5.01 g/cm³.
C: The density of the green compact is less than 4.99 g/cm³.

### 7.4. Coercive Force of Soft Magnetic Powder

The coercive force of the soft magnetic powder of each of Examples and Comparative Examples was measured. The coercive force thus measured was evaluated according to the following evaluation criteria. The evaluation results are shown in Tables 3 and 4.
A: The coercive force is less than 0.90 Oe.
B: The coercive force is 0.90 Oe or more and less than 1.33 Oe.
C: The coercive force is 1.33 Oe or more and less than 1.67 Oe.
D: The coercive force is 1.67 Oe or more and less than 2.00 Oe.
E: The coercive force is 2.00 Oe or more and less than 2.33 Oe.
F: The coercive force is 2.33 Oe or more.

### 7.5. Saturation Magnetic Flux Density of Soft Magnetic Powder

The saturation magnetic flux densities of the soft magnetic powders obtained in Examples and Comparative Examples were calculated. The calculation results are shown in Tables 3 and 4.

### 7.6. Magnetic Permeability of Green Compact

The magnetic permeability of the green compact manufactured using the soft magnetic powder obtained in each of Examples and Comparative Examples was measured. The measurement results are shown in Tables 3 and 4.

In Tables 3 and 4, among the soft magnetic powders of the respective sample numbers, those corresponding to the present disclosure are indicated as “Example,” and those not corresponding to the present disclosure are indicated as “Comparative Example.”

TABLE 3

| | | | | Evaluation Results of Green Compact, etc. | | | |
|---|---|---|---|---|---|---|---|
| | | Evaluation Results of | | | | Saturation | |
| | | Soft Magnetic Powder | | Green | | Magnetic | Magnetic |
| | | Crystallite | Oxygen | Compact | Coercive | Flux | Permeability |
| Sample | | Diameter | Content | Density | Force | Density | (1 MHz) |
| No. | Classification | nm | ppm | — | — | T | — |
| No. 1 | Comparative | 9.5 | 1025 | C | C | 1.05 | 23.4 |
| | Example | | | | | | |
| No. 2 | Examples | 9.3 | 630 | A | A | 1.35 | 24.7 |
| No. 3 | Comparative | 8.1 | 945 | C | B | 1.32 | 23.6 |
| | Example | | | | | | |
| No. 4 | Examples | 8.5 | 860 | B | B | 1.40 | 24.3 |
| No. 5 | Examples | 9.2 | 795 | B | B | 1.40 | 24.8 |
| No. 6 | Examples | 9.7 | 659 | A | A | 1.40 | 25.0 |
| No. 7 | Examples | 10.5 | 584 | A | A | 1.40 | 25.2 |
| No. 8 | Examples | 8.2 | 521 | A | B | 1.40 | 24.2 |
| No. 9 | Examples | 7.8 | 499 | A | C | 1.40 | 24.0 |
| No. 10 | Comparative | 5.5 | 480 | A | E | 1.35 | 23.0 |
| | Example | | | | | | |
| No. 11 | Comparative | 4.8 | 400 | A | B | 1.25 | 22.6 |
| | Example | | | | | | |
| No. 12 | Examples | 10.3 | 590 | A | A | 1.25 | 25.1 |
| No. 13 | Examples | 9.8 | 602 | A | B | 1.42 | 25.0 |
| No. 14 | Examples | 9.5 | 623 | A | C | 1.43 | 24.9 |
| No. 15 | Comparative | 25.0 | 1650 | C | F | 1.38 | 25.1 |
| | Example | | | | | | |

TABLE 4

| | | | | Evaluation Results of Green Compact, etc. | | | |
|---|---|---|---|---|---|---|---|
| | | Evaluation Results of | | | | Saturation | |
| | | Soft Magnetic Powder | | Green | | Magnetic | Magnetic |
| | | Crystallite | Oxygen | Compact | Coercive | Flux | Permeability |
| Sample | | Diameter | Content | Density | Force | Density | (1 MHz) |
| No. | Classification | nm | ppm | — | — | T | — |
| No. 16 | Examples | 12.8 | 625 | A | B | 1.40 | 25.1 |
| No. 17 | Examples | 10.3 | 573 | A | A | 1.40 | 25.2 |
| No. 18 | Examples | 10.1 | 560 | A | A | 1.40 | 24.8 |
| No. 19 | Examples | 9.8 | 534 | A | A | 1.39 | 24.6 |
| No. 20 | Examples | 8.5 | 460 | A | A | 1.38 | 24.3 |
| No. 21 | Comparative | 22.0 | 1100 | C | E | 1.38 | 23.5 |
| | Example | | | | | | |

As is obvious from Tables 3 and 4, in the soft magnetic powder of each Example, even when the content of Fe was high, the oxidation resistance was excellent, and the oxygen content was suppressed to be relatively low. In addition, it was confirmed that the green compacts manufactured using the soft magnetic powders of the respective Examples had high density and high magnetic permeability. Furthermore, in the soft magnetic powder of each Example, a reduction in coercive force was achieved regardless of the temperature rising rate.

From the above results, it was confirmed that according to the present disclosure, it is possible to manufacture a green compact having high density and high magnetic permeability, and it is possible to manufacture a soft magnetic powder which is easily manufactured with low coercive force.

In the soft magnetic powder having the same configuration as that of the above example except that the soft magnetic powder was manufactured using the water atomizing method instead of the rotary water flow atomizing method as well, there was obtained a result having the same tendency as that described above.

What is claimed is:

1. A soft magnetic powder in which a composition determined by an optical emission spectrometer (OES) is represented by a composition formula in an atomic number ratio FeₓCuₐNb_{b} (Si_{1-y}(B_{1-z}Cr_{z})_{y})_{100-x-a-b}, wherein
a, b, x, y, and z satisfy
$$\\ 0.3 \leq a \leq 2. , 2. \leq b \leq 4. , 75.5 \leq x \leq 79.5 , 0.55 \leq y \leq 0.91 , and$$
$$\\ 0.015 \leq z \leq 0.185 ,$$
the soft magnetic powder comprising:
an amorphous phase which is formed of an amorphous structure in which Fe is an element highest in concentration; and
a crystalline phase which is formed of a crystalline structure in which Fe is an element highest in concentration, wherein
defining a content [at %] of Cr determined by the optical emission spectrometer (OES) as X(Cr), and a content [at %] of Cr and a content [at %] of B in the amorphous phase determined by an energy dispersive X-ray fluorescence spectrometer (EDX) as Y(Cr) and Y(B), the following formulas (1) and (2) are satisfied,
$$\\ \begin{matrix}X ( Cr ) < Y ( Cr ) \leq X ( Cr ) + 1. & ( 1 )\end{matrix}$$
$$\\ \begin{matrix}3. \leq Y ( B ) \leq 15. & ( 2 )\end{matrix}$$

2. The soft magnetic powder according to claim 1, wherein
defining a content [at %] of Cr in the crystalline phase determined by the energy dispersive X-ray fluorescence spectrometer (EDX) as Z(Cr), the following formula (3) is satisfied,
$$\\ \begin{matrix}Z ( Cr ) < X ( Cr ) , & ( 3 )\end{matrix}$$
a content Y(B) [at %] of B in the amorphous phase determined by the energy dispersive X-ray fluorescence spectrometer (EDX) satisfies the following formula (4),
$$\\ \begin{matrix}3. \leq Y ( B ) \leq 10. & ( 4 )\end{matrix}$$

3. The soft magnetic powder according to claim 2, wherein
the content Y(Cr) [at %], the content Y(B) [at %], and the content Z(Cr) [at %] satisfy the following formulas (5) to (7),
$$\\ \begin{matrix}1.5 \leq Y ( Cr ) \leq 2.5 & ( 5 )\end{matrix}$$
$$\\ \begin{matrix}4. \leq Y ( B ) \leq 7. & ( 6 )\end{matrix}$$
$$\\ \begin{matrix}0.8 \leq Z ( Cr ) \leq 2. & ( 7 )\end{matrix}$$

4. The soft magnetic powder according to claim 1, wherein
an oxygen content is 1500 ppm or less.

5. A powder magnetic core comprising the soft magnetic powder according to claim 1.

6. A magnetic element comprising the powder magnetic core according to claim 5.

7. An electronic device comprising the magnetic element according to claim 6.
